(19) United States
(12) Patent Application Publication
(10) Pub. No.: US 2017/0168971 A1
(43) Pub. Date: Jun. 15, 2017

(54) RE-ENUMERATING MEDIA AGNOSTIC DEVICES

(71) Applicant: Intel IP Corporation, Santa Clara, CA (US)

(72) Inventors: Michael Glik, Kfar Saba (IL); Rafal Wielicki, Gdansk (PL); Bahareh Sadeghi, Portland, OR (US)

(21) Appl. No.: 14/969,531

(22) Filed: Dec. 15, 2015

(51) Int. Cl. G06F 13/38; G06F 13/40; G06F 13/42

(52) U.S. Cl. CPC G06F 13/385; G06F 13/4282; G06F 13/4068

(57) ABSTRACT

Generally discussed herein are devices and methods for media agnostic (MA) universal serial bus (USB) device enumeration. A device can include a transceiver and processing circuitry to perform a first enumeration process including the transceiver and processing circuitry to determine that throughput is denied based on a throughput negotiation performed in response to receiving a new device connection notification from an MA USB device attempting to communicate with the MA USB host, in response to a determination the throughput is denied, monitor the throughput available on the MA USB host to determine whether the throughput available on the MA USB host has increased, generate a throughput change notification in response to a determination the throughput available on the MA USB host has increased, and initiate a second enumeration process in response to a determination the throughput available on the MA USB host has increased.

### TECHNICAL FIELD

Examples generally relate to systems and methods for enumeration of devices. Some examples regard systems and methods for (automatic) re-enumeration of media agnostic (MA) universal serial bus (USB) devices.

### BACKGROUND

Predictable behavior and ease of use are two characteristics that have contributed to the popularity of USB devices. A USB device is one that includes a USB port or communicates using a USB protocol through a USB port. The MA USB is a technology whose standards are developed by the USB Implementers Forum (USB-IF). MA USB enables transport of USB format data and connection of USB devices to a USB host (for example a personal computer, smartphone, or tablet) via media other than USB, for example Wi-Fi or WiGig. The medium through which MA USB enabled device(s) communicate is not a USB cable, but the communication protocol of the signals transferred using the medium generally conform to the MA USB specification so as to allow use of USB class drivers on a host device. The medium through which MA USB enabled devices communicate can include a wireless or a wired communication medium.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates, by way of example, a block diagram a system for MA USB device communication in accord with one or more embodiments.

FIG. 2 illustrates, by way of example, a flow diagram of communications between an MA USB host and an MA USB device in accord with one or more embodiments.

FIG. 3 illustrates, by way of example, another flow diagram of communications between the MA USB host and the MA USB device in accord with one or more embodiments.

FIG. 4 illustrates, by way of example, a list of devices that have failed enumeration due to lack of sufficient available throughput in accord with one or more embodiments.

FIG. 5 illustrates, by way of example, a machine on which one or more methods discussed herein may be performed in accord with one or more embodiments.

### DETAILED DESCRIPTION

Examples in this disclosure relate generally to media agnostic (MA) universal serial bus (USB) device enumeration. In one or more embodiments, this disclosure considers monitoring available throughput of an MA USB enabled device (e.g., an MA USB host, an MA USB device, and/or a peripheral device that is MA USB enabled by virtue of a connection to an operating MA USB hub) and (re-) initiating an enumeration process in response to determining available throughput has (sufficiently) increased. Note that the term “USB device” refers generally to a device that includes USB class drivers and can be connected to an MA USB hub. Throughput of a device is affected by many factors, such as can include available bandwidth of a communication medium, circuitry, communication protocol, processor speed, transient signal settling times, and so forth.

As used herein, “MA USB host” is a device includes MA USB host circuitry (circuitry configured to implement the operations to be performed by the MA USB host detailed in the MA USB standard). The MA USB host can perform USB host functions, such as is defined in the USB 2.0 and 3.1 specifications, as well as management of MA USB devices and an MA Link Interface (LI). The MA USB host is typically the device a user is operating and through which other MA USB enabled device functionality is available to the user.

As used herein “MA USB device” is a device to communicate with the MA USB host. Generally, the MA USB device is the counterpart to the MA USB host and enables remote connectivity to one or more peripheral devices. A special example of an MA USB device is an MA USB hub. The MA USB hub can include a plurality of ports (e.g., USB or other ports) and exposes one or more devices connected thereto (termed “non-MA USB devices” herein”) as USB devices, thus providing MA USB connection capability to a device that does not have such a connection capability. The non-MA USB device is connected to the MA USB hub and the MA USB host communicates to the non-MA USB device through the MA USB hub. In such embodiments, the MA USB hub acts as a sort of surrogate for the USB device. The non-MA USB device can be a standard USB device (a device that conforms to non-MA USB specification), Ethernet device, secure digital (SD) device, headphone or other speaker device, monitor device (e.g., a digital video interface (DVI), DB9, and so forth), lightning device, and so forth. Note that an “Ethernet device” is a device that can communicate with another device using an Ethernet communication protocol (through an Ethernet port), a headphone or speaker device is a device that can communicate through a headphone port, and so forth.

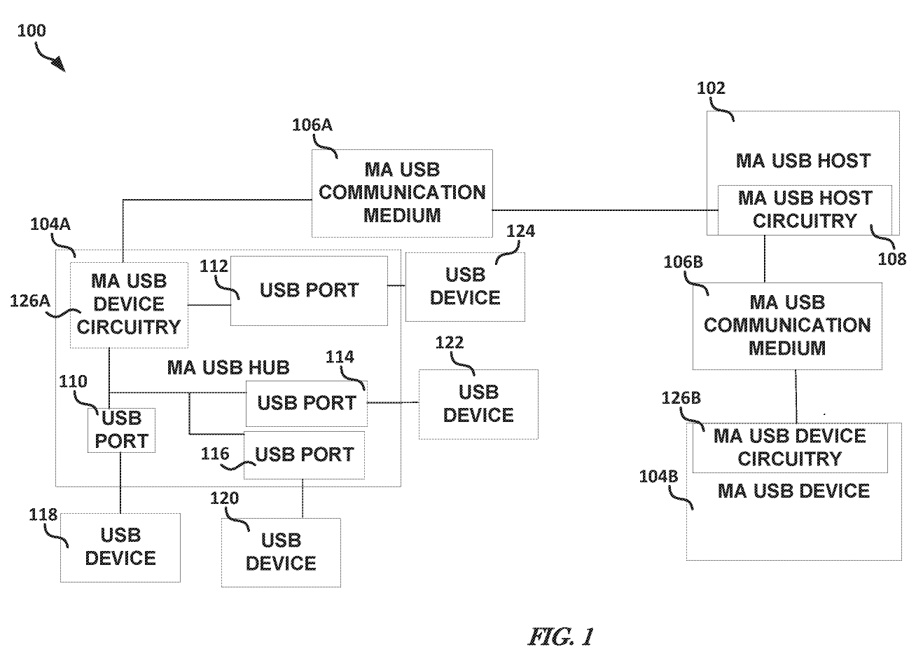

FIG. 1 illustrates, by way of example, an embodiment of a system 100 for MA USB communication. The system 100 as illustrated includes an MA USB host 102 communicatively coupled to an MA USB hub 104A through a communication medium 106A. The system 100 as illustrated also includes a second MA USB device 104B communicatively coupled to the MA USB host 102 through another MA USB communication medium 106B.

The MA USB host 102 includes MA USB host circuitry 108. The MA USB host circuitry can be communicatively coupled to zero or more input/output (I/O) ports (the ports are shown as part of the MA hub 104A in FIG. 1). The MA USB host circuitry 108 includes electric and/or electronic components (e.g., one or more transistors, resistors, capacitors, inductors, diodes, integrated circuits, processors (e.g., central processing units (CPUs)), memories, logic gates, oscillators, switches, multiplexers, antennas, transmit or receive radios (e.g., transceivers), and/or so forth) configured to implement an MA USB host communication protocol.

The MA USB hub 104A is a specific example of an MA USB device that provides MA USB capability to non-MA USB devices. The MA USB hub 104A includes one or more USB ports 110, 112, 114, and/or 116. Note that while the MA USB hub 104A is illustrated as including only USB ports, other ports can be supported by the MA USB hub 104A. For example, the ports can include a headphone or speaker port, a lightning port, an Ethernet port, a monitor port (e.g., a D-subminiature connector port, Digital Visual Interface (DVI) (e.g., standard, mini, or micro DVI) port, Video Graphics Array (VGA) port, High Definition Multimedia Interface (HDMI) port, and so forth), microphone port, and/or so forth.

A non-MA USB device, illustrated, for example, as a USB device 118, 120, 122, and 124 is communicatively coupled to a respective port 110, 116, 114, and 112 of the MA USB hub 104A. The non-MA USB device communicates, through the respective port in its native data format and with MA USB device circuitry 126A. Generally, the MA USB device circuitry 126A receives signals from a non-MA USB device connected to the MA USB hub 104A, converts the signals to a format compatible with the MA USB communication medium 106A, and transmits the signals through the MA USB communication medium 106A. For example, if the MA USB communication medium 106A is a Wi-Fi communication medium, the MA USB device circuitry 126A converts signals received from the non-MA USB device to a format compatible with the Wi-Fi communication medium, re-packetizes the formatted data, and initiates a new message. The signals from the MA USB device circuitry 126A in the format compatible with the Wi-Fi communication medium are decodable by the same circuitry logic that is used to decode USB communications.

The MA USB communication medium 106A can be a wired or wireless communication medium. In one or more embodiments, the MA USB communication medium 106A operates using a Wi-Fi, WiGig, Ethernet, WiMedia UWB, other wireless or a wired communication medium (e.g., monitor, speaker, microphone, lightning, or other media types). The physical communication medium 106A carries signals conforming to the MA USB communication protocol. That is the signals through the communication medium 106A are packetized, timed, sized (in amplitude and/or magnitude), and asserted or de-asserted at frequency(s) that conform to the MA USB standard(s).

Consider a non-MA USB device that is a USB device and a communication medium that is a WiGig communication medium. The MA USB host circuitry 108 can include the same circuitry as it does (assuming it is already WiGig and USB compliant) with a new driver to allow the USB device communications to be transmitted over the WiGig medium. Translation circuitry may be needed where a non-MA USB device that is not a USB device, such as an Ethernet, lightning, microphone, monitor, headphone or speaker, or other device is to communicate using USB protocol over the MA USB communication medium. The translation circuitry will convert Ethernet communication signals, for example, to a USB format for signals to be sent to the MA USB device 104A through the communication medium 106A and convert USB signals from the communication medium 106A to an Ethernet format for signals from the MA USB device 104A to the Ethernet device.

Any two MA USB enabled devices can communicate with each other as long as MA USB host circuitry 108 is present on one of the devices and MA USB device circuitry 126A-B or MA USB host circuitry 108 is present on the other device.

An MA USB hub device is different from a non-hub MA USB device in that the hub has one or more ports through which a device can be connected to communicate using MA USB communication medium, while the MA USB device 104B has only zero or one such ports, but can communicate to other MA USB enabled devices, such as the MA USB device 104B, the MA USB host 102, or a non-MA USB device that is MA USB enabled by virtue of being connected to the MA USB hub 104A. The MA USB device 104B may not provide other devices MA USB capability, but has MA USB capability itself. Each MA USB device 104B includes MA USB device circuitry 126B, respectively. The MA USB device circuitry 126B provides capability to implement a communication protocol conforming to the MA USB standard, namely a USB communication over a communication medium other than USB cable 106A-B.

Wireless connectivity of devices and transport of USB traffic over a wireless MA USB communication medium can enhance user experience, but can also introduce challenges in maintaining predictable behavior of a connected device. One or more of these challenges is due, at least in part, to a transient nature of the wireless communication medium through which the devices can communicate. The available throughput of the wireless medium is subject to bigger changes than a corresponding wired medium, since the wired medium generally includes a static throughput availability. A problem encountered using wireless transport of USB traffic can include a temporary throughput degradation impacting user experience of the USB device. For example, a user can be attempting to provide USB traffic over the wireless medium or attempting to connect to the wireless medium for a first time. The wireless medium can be either a Wi-Fi, WiGig, WiMedia Ultra Wideband (UWB) connection or any other wireless medium that can suffer from transient fluctuations in throughput.

The MA USB enabled device can be either connected downstream of an MA USB host (e.g., connected directly to an MA USB host), or a device dedicated to providing MA USB capability to other devices or a computing device (e.g., a laptop, desktop, tablet, smartphone, or other computing device), such as an MA USB hub. If a throughput degradation occurs at or around a time that the USB device is connected for the first time or is otherwise subject to being enumerated, the transient lack of sufficient throughput may cause a failure in enumeration of the USB device.

Currently, using an MA USB communication protocol, as defined in the MA USB standard from the USB IF, if a device enumeration fails, the recovery of channel throughput does not reinitiate enumeration. To enumerate a device that has failed enumeration, using the current MA USB standard, a user can disconnect and reconnect the MA USB enabled device, or can eject the device and re-trigger discovery of the device. In either case, the user may repeat the reconnect action multiple times before the throughput of the MA USB communication medium has recovered sufficiently to perform enumeration of the device. Existing solutions to the device enumeration issue either ignore throughput check at the time of enumeration, which results in poor performance of the device and disappointing user experience, or make a device fail enumeration permanently and require a user to act as previously described.

To address one or more of the enumeration and/or user experience problems, a throughput change notification communication can be provided from a wireless radio (the radio can be a part of the circuitry 108 or 126A-B) of an MA USB enabled device (e.g., the MA USB host 102 or, the MA USB device 104B) to another MA USB enabled device (e.g., the MA USB host 102 or the MA USB device 104A-B) to notify the other MA USB enabled device when the throughput availability has improved. The throughput can be monitored by the MA USB host 102, the MA USB device 104B, or the MA USB hub 104A. The MA USB enabled device can then (e.g., automatically) reinitiate the enumeration for one or more devices whose enumeration had failed due to lack of throughput. In one or more embodiments, the throughput change notification communication includes the actual throughput increase, a total throughput available, and/or an indication that sufficient throughput is now available on the MA USB enabled device. Such a notification enables the MA USB enabled device to choose the device(s) that failed enumeration to be re-enumerated and/or the order of enumeration of the devices.

One or more embodiments are useful not only when lack of throughput is due to the lack of throughput available at the MA USB communication medium 106A-B, but also when too many devices have “reserved” throughput on an MA USB enabled device, such that the reserved throughput has made the throughput available at the MA USB enabled device insufficient for enumeration or performing operations of the MA USB enabled device to be enumerated. For example, if one of the devices connected to the MA USB host or a USB device connected to an MA USB hub is disconnected and its throughput becomes available, the enumeration of the failed devices can be re-initiated, such as to utilize the freed throughput.

The existing solutions to re-enumerating the devices that have attempted to communicate over the MA USB communication medium 106A-B and failed provide a poor performance and user experience by not checking whether the minimum throughput required by the device/application is available. With the existing solutions, the device, even if successfully enumerated may not be functioning as expected and applications may experience very high latency; both potentially impacting user experience. Alternatively, other solutions choose simply to stop when the enumeration fails which leads to unpredictable behavior from user's perception: 1) successful enumeration may or may not happen depending on the channel conditions and the throughput availability when the user connects the device; and 2) the required actions to fix it are not predictable. A solution to these problems proposed herein restores devices back to operational state in response to determining sufficient throughput is available for communication over the MA USB communication medium 106A-B. Using such an approach, failed enumerations due to lack of throughput can be tolerated and devices can be re-enumerated and restored to a communicating state.

A solution proposed herein includes modification of the existing MA USB enabled device enumeration conditions by adding throughput availability (e.g., throughput negotiation and/or throughput change notification), timer operation, re-initiating enumeration, pinging a device, and/or prompting a user for a course of action in addition to device plug in/discovery.

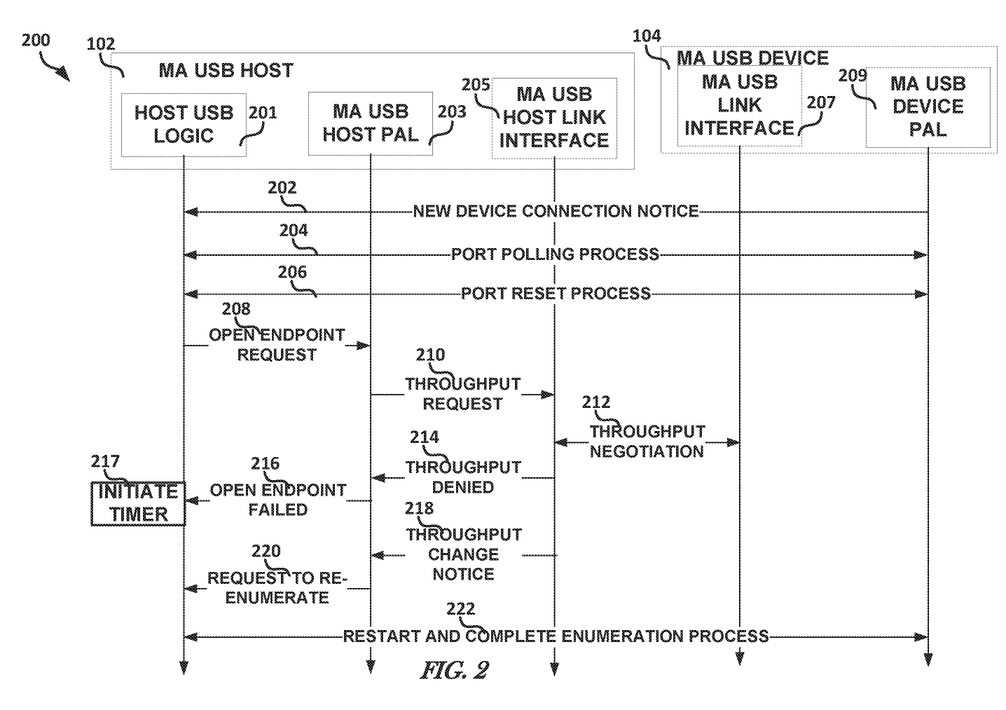

FIG. 2 illustrates, by way of example, a flow diagram of communications 200 between two MA USB enabled devices. The communications 200 are illustrated as being between the MA USB host 102 and the MA USB device 104 (reference number 104 referring generally to either of the MA USB devices 104A-B). The MA USB host is a device that can act as an MA USB host as defined in the MA USB standard and the MA USB device is a device that can act as an MA USB device as defined in the MA USB standard. Note that the terms “standard” and “specification” are used interchangeably herein.

The communications 200 include an extension to an MA USB device enumeration process. The communications can be triggered by interaction (notification) with corresponding transport layer(s) regarding throughput availability changes at the MA USB device 104 or the MA USB host 102, such as can be through the MA USB communication medium 106 (reference numeral 106 referring generally to either of the communication mediums 106A and 106B). This sort of throughput availability is currently not supported by the wired USB stack, as the traditional wired USB bus has generally statically allocated throughput. With MA USB and transport of USB traffic over wireless medium, there is a need to address the dynamic nature of throughput availability in presence of expectations of wired USB for static throughput, as previously discussed.

The MA USB host 102 includes host USB logic 201, an MA USB host protocol adaptation layer (PAL) 203, and an MA USB host link interface (LI) 205. Each of the host USB logic 201, the MA USB host PAL, and the MA USB LI 205 can be part of the MA USB host circuitry 108. The MA USB device 104 includes, such as can be a part of the MA USB device circuitry 126A-B, an MA USB LI 207 and an MA USB device PAL 209. The PAL and LI are defined in the MA USB standard, titled “Media Agnostic Universal Serial Bus Specification”, release 1.0, published Feb. 25, 2014, and currently available at http://www.usb.org/developers/docs/devclass_docs/ (last accessed Oct. 26, 2015), which is incorporated by reference herein in its entirety. The MA USB host PAL manages the MA USB devices and transport of USB payload over an MA link. The MA USB host LI is responsible for providing generic packet transport services to MA USB host PAL without exposing it to the low level details of specific transport. The USB host logic 201 provides USB host functionality that performs USB host functions defined by the USB 2.0 and USB 3.1 specifications, except those that involve the physical USB medium, as well as extra functions to manage the MA USB devices and MA LI. The USB 2.0 specification is titled “Universal Serial Bus Specification”, revision 2.0, available at http://www.usb.org/developers/docs/usb20_docs/#usb20spec (last accessed Oct. 26, 2015), and is incorporated by reference herein in its entirety. The USB 3.1 specification is titled “Universal Serial Bus 3.1 Specification”, revision 1.0, available at http://www.usb.org/developers/docs/ (last accessed Oct. 26, 2015), and is incorporated by reference herein in its entirety

The communications 200 begin with the host USB logic 201 becoming aware of a device (e.g., a new device) becoming connected and beginning an enumeration process. The enumeration process begins with a new device connection notice at communication 202. The communication 202 can be pending an interrupt USB request block (URB) completion, such as in the case of a USB device newly connected to an MA USB hub. The communication 202, in the case of an MA USB hub or an MA USB device directly connecting (i.e. not through an MA USB hub) to the MA USB host, can come out of band. For example, discovery can occur per mechanisms defined in a specification from the Wi-Fi Alliance, which can trigger a signal in the MA USB host. The communication 202 can be from the MA USB device PAL 209 to the host USB logic 201. A port polling process is performed at communication 204 and a port reset process is performed at communication 206. The port polling and reset processes, among other enumeration process functions, can include operations as detailed in the MA USB specification at section 7.3.2, 7.3.3, and 9.1, among others. These communications can be between the MA USB device PAL 209 and the host USB logic 201.

At communication 208 the MA USB host 102 is ready to create a USB device connection and initiates endpoint creation. The MA USB host 102 provides an open endpoint request communication 208 from the host USB logic 201 to the MA USB host PAL 203. A throughput request communication 210 can be provided from the MA USB host PAL 203 to the MA USB host LI 205. The communication 210 can be provided based on the device type of the device to be connected. The throughput request communication is provided to the MA USB host LI 205 (i.e. a media access control (MAC) layer for a Wi-Fi or WiGig communication medium). A throughput negotiation communication 212 can occur between the MA USB host LI 205 and the MA USB LI 207. The throughput negotiation communication 212 can include a communication indicating an amount of throughput required to reliably communicate with the MA USB device 104. The throughput negotiation can include a communication from the MA USB host LI 205 to the MA USB LI 207 (or vice versa) indicating an amount of throughput available at the respective host 102 or device 104. The throughput negotiation communication 212 can include comparing (at the MA USB host 102 or the MA USB device 104) the available throughput and the required throughput and determining if there is sufficient throughput for the device to communicate reliably over the communication medium (e.g., MA USB communication medium 106).

In response to a determination that the throughput is insufficient, a throughput denied communication 214 is provided from the MA USB host LI 205 to the MA USB host PAL 203. The MA USB host PAL 203 then provides an open endpoint failed communication 216 to the host USB logic 201.

The MA USB device 104, using the MA USB device circuitry 126, or the MA USB host 102, using the MA USB host circuitry 108, monitors the throughput available at the respective device 104 or host 102. If the throughput at the device 104 or the host 102 increases (e.g., by a threshold amount or to be greater than (or equal to) the required throughput) the MA USB host LI 205 can provide a throughput change notice communication 218 to the MA USB host PAL 203. The throughput change notice communication 218 can include the amount of throughput now available to the host 102 or the device 104 or can include a delta indicating the amount the throughput has increased since the throughput negotiation communication(s) 212.

In response to receiving the throughput change notice communication 218, the MA USB host PAL 203 can provide a communication 220 to the host USB logic 201 indicating to initiate another enumeration of a device that failed enumeration due to lack of throughput. The MA USB host 102 and the MA USB device 104 can then re-perform an enumeration process. The enumeration process is described in the MA USB specification.

Optionally, at operation 217, the host USB logic 201 can initiate a timer, such as can be in response to receiving the open endpoint failed communication 216. The timer can be a part of the MA USB host circuitry 108 or the MA USB device circuitry 126A-B. If a throughput change notice communication 218 is received at the MA USB host PAL 203 and the MA USB host PAL 203 provides the communication 220 to the host USB logic 201 while the timer is still live (before the time expires), the host USB logic 201 can (automatically, such as without human interference after deployment) re-initiate enumeration, such as by providing the communication 222. After the enumeration process is complete, the device is successfully enumerated and available for use by a user.

FIG. 2 illustrates system level communications, such as can be observable by a user. As is illustrated in FIG. 2 the MA USB stack provides a notification from a transport layer indicating that throughput has improved, as well as quantifying the improvement (by indicating how much throughput has become available since the throughput negotiation communication 212, or the amount of total available throughput at the time of the notification). With the flow illustrated in FIG. 2, there is no need for the user to re-connect the device once the throughput becomes available, such as can help improve user experience.

In one or more embodiments, the MA USB host 102 can maintain a list of devices that have failed enumeration due to lack of throughput. The MA USB host 102 can prioritize the devices on the list (if there is more than one such device), such as by setting a corresponding priority value or ordering the list of devices in order of priority. Depending on the amount of throughput that becomes available, the MA USB host 102 can choose the device(s) to be re-enumerated. The list of devices that have failed for lack of throughput can include a corresponding amount of throughput required for proper operation of the device. The MA USB host circuitry 108 can compare the throughput available to the throughput required and re-enumerate device(s) with 1) a highest priority that can be serviced with the available throughput, 2) devices with throughput requirements from most to least (or least to most throughput required) that can be serviced with the available throughput, 3) or other heuristic, such as can include input from a user.

To maintain a valid list of devices, the MA USB host 102 can record when a device is removed. Depending on the device type and the media there are different mechanisms available to learn whether an MA USB device is no longer available: 1) in case of a wired USB device connected to an MA USB hub, the MA USB hub can notify the MA USB host when a USB device (or other device) is removed, 2) in case of an MA USB device, depending on the MA USB device implementation and the communication medium, such notification may or may not be sent to the MA USB host.

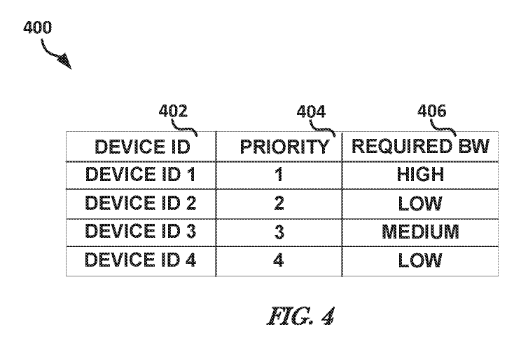

In order for the MA USB host to maintain an up-to-date list of devices, the MA USB host can maintain a timer for each device. The timer is set at the time that the MA USB Host receives the throughput denied notification. The MA USB host may follow different policies for keeping the USB device on the list following the expiration of the timer: it may notify the user and ask the user whether enumeration is to be retried, it may send an MA USB device reset request (DevResetReq) packet targeted to the MA USB enabled device and if the device responds, the MA USB host resets the timer, and if not, removes the MA USB enabled device from the priority list (see FIG. 4 for an example of a priority list).

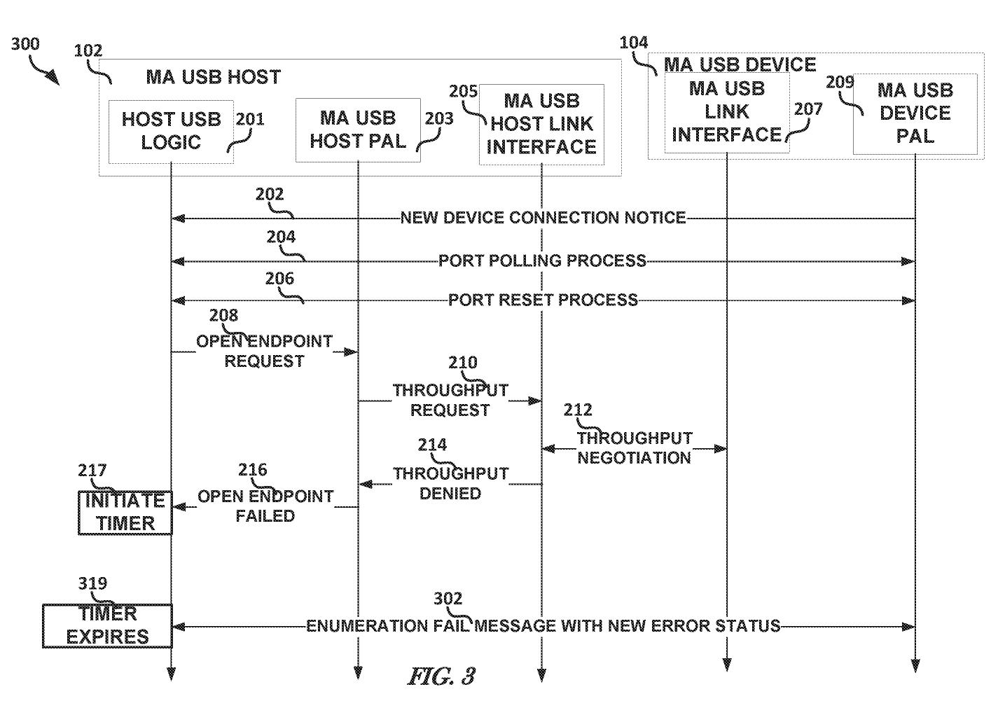

FIG. 3 illustrates, by way of example, a flow diagram of communications 300 between two MA USB enabled devices 102 and 104. The communications of FIG. 3 are similar to the communications 200 of FIG. 2 with the communications 300 depicting communications provided if the timer expires before a sufficient change in throughput at the MA USB host 102 and/or the MA USB device 104. The communications 202, 204, 2006, 208, 210, 212, 214, and 216 are the same as communications described with regard to the communications 200 of FIG. 2.

Similar to FIG. 2, at operation 217, the host USB logic 201 can initiate a timer in response to an open endpoint action failing, such as can be indicated by receiving the open endpoint failed communication 216. The timer can be a part of the MA USB host circuitry 108. If no throughput change notice communication 218 (see FIG. 2) is received at the MA USB host PAL 203 and the timer expires at 319 the host USB logic 201 can provide a communication 302 to the MA USB device PAL 209 indicating that enumeration has failed. The communication 302 can include an error status indicating a reason that enumeration failed (e.g., insufficient throughput or “bad_link_conditions”, and so forth). If the MA USB device 104, the MA USB device host 102, or a peripheral device connected to an MA USB hub that includes audio (e.g., a speaker) or visual capability (e.g., light emitting diode(s), a display screen, and so forth) can provide a user with a corresponding audio or visual notification that enumeration has failed, such as device may do so. The notification can provide a user with one or more options for continuing to wait until sufficient throughput is available or removing the device from the list of devices that have failed enumeration. In one or more embodiments, the host USB logic 201 pings the device to be connected over MA USB and if the device responds, the MA USB host 102 resets the timer corresponding to that device. If the device does not respond to one or more pings (e.g., devresetreq packet), the MA USB host 102 can remove the device from the list of devices that have failed enumeration.

FIG. 4 illustrates, by way of example, an embodiment of a list 400 of devices that have failed enumeration due to lack of throughput. Data corresponding to the items shown in the list 400 can be stored in a memory of the MA USB host circuitry 108, such as the host USB logic 201. The list 400 as illustrated includes a device identification (ID) 402, a corresponding device priority 404 for each device ID listed, and a corresponding required throughput 406 for each device ID listed.

Consider an embodiment in which the host USB logic 201 is provided with a throughput change notice communication (before the timer expires) indicating that a medium amount of throughput is now available for devices that have failed enumeration. The host USB logic 201 then determines which devices in the list 400 to re-initiate enumeration. There are many heuristics possible, but consider a heuristic which requires the host USB logic 201 to re-enumerate based on priority. Since the highest priority device, the device corresponding to device ID 1, requires a high amount of throughput and there is only a medium amount of throughput available in this example, the highest priority device cannot be enumerated. In one or more embodiments, the host USB logic 201 can stop there and wait for a high amount of throughput availability. In one or more other embodiments, the USB host logic 201 can determine which device with the highest priority can be enumerated with the available throughput. The next highest priority device in this example is the device corresponding to the device ID 2. This device can be enumerated, so in this embodiment the host USB logic 201 can initiate an enumeration process for this device. After successful enumeration, the host USB logic 201 can remove the device that was successfully enumerated from the list 400. The host USB logic 201 can continue the process until there is insufficient throughput to support any of the devices on the list 400, such as to initiate enumeration for zero or more of the remaining lower priority devices on the list 400 for which sufficient throughput is available.

Consider another example in which devices are enumerated to best use up the available throughput. Using such a heuristic, the device corresponding to device ID 3 can be enumerated since it requires a medium amount of throughput and there is a medium amount of throughput available. Consider yet another example in which devices are enumerated to remove as many devices from the list as possible. Using such a heuristic, the devices that require smaller amounts of throughput receive priority over devices that require relatively larger amounts of throughput. In context of the devices on the list 400, the devices corresponding to device IDs 2 and 4 will be enumerated before the devices corresponding to the device IDs 1 and 3. Many other heuristics are possible, such as highest required throughput gets enumerated first, first in first out (FIFO), user selectable priorities or heuristic(s), and so forth.

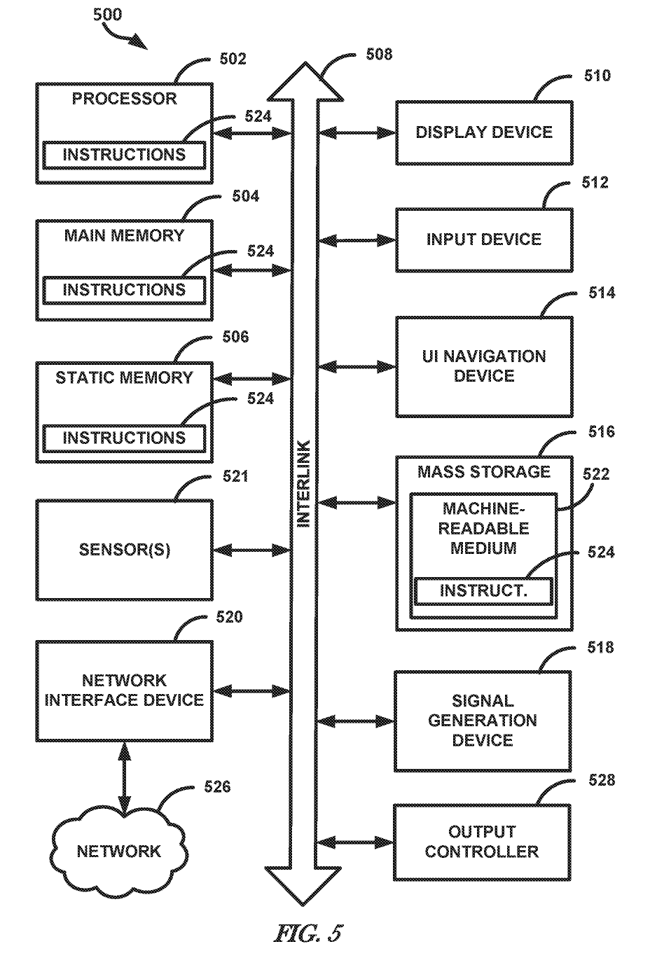

FIG. 5 illustrates, by way of example, a block diagram of an embodiment of a machine 500 on which one or more of the methods as discussed herein can be implemented. The machine 500 can be a part of an MA USB host 102 and MA USB device 104, and/or a peripheral device. One or more of the MA USB host 102, MA USB device 104, MA USB communication medium 106A-B, MA USB host circuitry 108, MA USB device circuitry 126A-B, USB device 118, 120, 122, and/or 124, host USB logic 201, MA USB host PAL 203, MA USB host LI 205, MA USB device LI 207, and/or MA USB device PAL 209 can include one or more of the items of the machine 300. In one or more embodiments, MA USB host 102, MA USB device 104, MA USB communication medium 106A-B, MA USB host circuitry 108, MA USB device circuitry 126A-B, USB device 118, 120, 122, and/or 124, host USB logic 201, MA USB host PAL 203, MA USB host LI 205, MA USB device LI 207, and/or MA USB device PAL 209 can be implemented by the machine 500. In alternative embodiments, the machine 500 operates as a standalone device or may be connected (e.g., networked) to other machines. Further, while only a single machine is illustrated, the term “machine” shall also be taken to include any collection of machines that individually or jointly execute a set (or multiple sets) of instructions to perform any one or more of the methodologies discussed herein.

The example machine 500 includes a processor 502 (e.g., a central processing unit (CPU), a graphics processing unit (GPU) or both), a main memory 504 and a static memory 506, which communicate with each other via a bus 508. The machine 500 may further include a video display unit 510 (e.g., a liquid crystal display (LCD) or a cathode ray tube (CRT)). The machine 500 may include an alphanumeric input device 512 (e.g., a keyboard), a user interface (UI) navigation device 514 (e.g., a mouse), a disk drive unit 516, a signal generation device 518 (e.g., a speaker) and a network interface device 520.

The memory 504 or 506 are examples of a storage device that can include instructions stored thereon that are executed by a machine, such as a processor or other processing circuitry, and cause the machine to perform operations. The storage device can be programmed and maintained prior to its inclusion in a BIT system. The instructions and other information can be encrypted or otherwise protected by one or more security measures, such as to help protect the operational boundaries and other data stored thereon.

The disk drive unit 516 includes a machine-readable medium 522 on which is stored one or more sets of instructions and data structures (e.g., software) 524 embodying or utilized by any one or more of the methodologies or functions described herein. The instructions 524 may also reside, completely or at least partially, within the main memory 504 and/or within the processor 502 during execution thereof by the computer system 500, the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, analog switches or circuits, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 524 may further be transmitted or received over a communications network 526 using a transmission medium. The instructions 524 may be transmitted using the network interface device 520 and any one of a number of transfer protocols (e.g., File Transfer over TCP/IP, UDP, etc.). Examples of communication networks include a local area network (“LAN”) and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Certain embodiments are described herein as including logic or a number of components, modules, or mechanisms. Examples of items that can be implemented using modules and described herein include the MA USB host 102, MA USB device 104, MA USB communication medium 106A-B, MA USB host circuitry 108, MA USB device circuitry 126A-B, USB device 118, 120, 122, and/or 124, host USB logic 201, MA USB host PAL 203, MA USB host LI 205, MA USB device LI 207, and/or MA USB device PAL 209. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

In one embodiment, the modules are written in a computer-programming and/or scripting language. Examples of such languages include, but are not limited to, C, C++, C#, Java, JavaScript, Perl, Python, or any other computer programming and/or scripting language now known or later developed.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

In an example, the hardware can include configurable execution units (e.g., transistors, logic gates (e.g., combinational and/or state logic), circuits, etc.) and a machine readable medium containing instructions, where the instructions configure the execution units to carry out a specific operation when in operation. The configuring can occur under the direction of the executions units or a loading mechanism. Accordingly, the execution units (e.g., processing circuitry, such as can include one or more hardware processors, transistors, resistors, capacitors, inductors, state machines or other logic gates, multiplexers, radios, sensors or other electrical or electronic components) can be communicatively coupled to the machine readable medium when the device is operating. In this example, the execution units can be a user (e.g., personnel) of more than one module. For example, under operation, the execution units can be configured by a first set of instructions to implement a first module at one point in time and reconfigured by a second set of instructions to implement a second module. The system 200 as illustrated includes a plurality of separate modules. The modules can be implemented with the division of operations as explained herein or the division of operations can be different such that a single module implements one or more of the operations of two or more of the modules or multiple modules implement the operations of one of the modules.

### Additional Notes

The present subject matter may be described by way of several examples.

Example 1 may include or use subject matter (such as an apparatus, a method, a means for performing acts, or a device readable memory including instructions that, when performed by the device, may configure the device to perform acts), such as may include or use a media agnostic (MA) universal serial bus (USB) host comprising processing circuitry and a transceiver communicatively coupled to processing circuitry, the transceiver and processing circuitry to perform a first enumeration process, including the transceiver and processing circuitry to determine that throughput is denied based on a throughput negotiation performed in response to receiving a new device connection notification from an MA USB device attempting to communicate with the MA USB host, in response to a determination the throughput is denied, monitor the throughput available on the MA USB host to determine whether the throughput available on the MA USB host has increased, generate a throughput change notification in response to a determination the throughput available on the MA USB host has increased, and initiate a second enumeration process in response to a determination the throughput available on the MA USB host has increased.

Example 2 can include or use, or can optionally be combined with the subject matter of Example 1, to include or use, wherein the transceiver and processing circuitry are further to initiate a timer in response to a determination the throughput is denied, and in response to the timer expiring and a determination the throughput available at the MA USB host has not increased sufficiently, provide an indication to the MA USB device that the first enumeration has failed.

Example 3 can include or use, or can optionally be combined with the subject matter of Example 2, to include or use, wherein the determination the throughput available at the MA USB host has not increased sufficiently includes a determination that the throughput has not increased by a threshold amount or enough to accommodate one or more devices that have failed the first enumeration due to lack of throughput.

Example 4 can include or use, or can optionally be combined with the subject matter of at least one of Examples 1-3, to include or use, wherein the transceiver and processing circuitry to monitor the throughput available on the MA USB host to determine if the throughput available on the MA USB host has increased includes transceiver and processing circuitry to determine if the throughput available has increased by a threshold amount.

Example 5 can include or use, or can optionally be combined with the subject matter of at least one of Examples 1-4, to include or use, wherein the transceiver and processing circuitry to monitor the throughput available on the MA USB host to determine if the throughput available on the MA USB host has increased includes transceiver and processing circuitry to determine if the throughput available has increased to an amount sufficient to support communication between the MA USB device and the MA USB host.

Example 6 can include or use, or can optionally be combined with the subject matter of Example 5, to include or use, wherein the transceiver and processing circuitry are further to perform the throughput negotiation with the MA USB device include the transceiver and processing circuitry to receive a required throughput from the MA USB device and wherein the transceiver and processing circuitry to determine if the throughput available has increased to an amount sufficient to support communication with the MA USB device includes the transceiver and processing circuitry to determine if the available throughput is greater than or equal to the provided required throughput.

Example 7 can include or use, or can optionally be combined with the subject matter of at least one of Examples 1-6, to include or use, wherein the transceiver and processing circuitry to provide the throughput change notification includes the transceiver and processing circuitry to provide an indication of the amount of throughput available on the MA USB device.

Example 8 can include or use, or can optionally be combined with the subject matter of at least one of Examples 1-7, to include or use, wherein the transceiver and processing circuitry to monitor the throughput available on the MA USB host to determine whether the throughput available at the MA USB host has increased includes the transceiver and processing circuitry to periodically determine currently available throughput at the MA USB host.

Example 9 can include or use, or can optionally be combined with the subject matter of at least one of Examples 1-8, to include or use, wherein the processing circuitry is further to in response to a determination the throughput is denied based on the throughput negotiation, record a device identification and throughput required for communication with the MA USB device on a list of devices that have failed enumeration, and in response to the throughput change notification, initiate the second enumeration process for those devices on the list of devices that failed enumeration and for which sufficient throughput is available at the MA USB host.

Example 10 can include or use, or can optionally be combined with the subject matter of at least one of Examples 1-9, to include or use, wherein the processing circuitry is further to, in response to determining that throughput is denied based on the throughput negotiation, record a device identification, throughput required for the non-MA USB device, and a priority of the MA USB device on a list of devices that failed enumeration, and wherein the second enumeration process is initiated for a device with a highest priority on the list of devices that failed enumeration.

Example 11 can include or use, or can optionally be combined with the subject matter of Example 10, to include or use, wherein the priority includes first come first served, and the transceiver and processing circuitry to initiate the second enumeration process includes transceiver and processing circuitry to initiate the second enumeration process for a device in the list with the highest priority that has a required throughput less than or equal to the throughput available at the MA USB host.

Example 12 can include or use, or can optionally be combined with the subject matter of at least one of Examples 1-11, to include or use, wherein the transceiver and processing circuitry to initiate the second enumeration process in response to a determination the throughput available on the MA USB host has increased includes the processing circuitry to provide an enumeration initiation communication to the MA USB device, receive another new device connection notification from the MA USB device attempting to connect to the MA USB host, perform another throughput negotiation with the MA USB device, and perform an open endpoint process, in response to determining there is sufficient throughput based on the throughput negotiation.

Example 13 may include or use subject matter (such as an apparatus, a method, a means for performing acts, or a device readable memory including instructions that, when performed by the device, may configure the device to perform acts), such as may include or use a media agnostic (MA) universal serial bus (USB) device comprising a transceiver and processing circuitry to initiate a first enumeration process by providing a new device connection notification to an MA USB host, perform the first enumeration process including the transceiver and processing circuitry to perform a throughput negotiation with the MA USB host, and determine that throughput is denied based on the throughput negotiation, provide a throughput change notification to the MA USB host in response to determining the throughput is denied and throughput available at the MA USB device has increased, and perform a second enumeration process in response to receiving an enumeration request from the MA USB host and after providing the throughput change notification to the MA USB host.

Example 14 can include or use, or can optionally be combined with the subject matter of Example 13, to include or use, wherein the processing circuitry is further to initiate a timer in response to determining that the throughput is denied, and in response to the timer expiring and determining that the throughput available on the MA USB device has not increased, determining that the first enumeration process has failed.

Example 15 can include or use, or can optionally be combined with the subject matter of at least one of Examples 13-14, to include or use, wherein the transceiver and processing circuitry to monitor the throughput available on the MA USB device to determine if the throughput available on the MA USB device has increased includes the transceiver and processing circuitry to determine if the throughput available has increased by a threshold amount.

Example 16 can include or use, or can optionally be combined with the subject matter of at least one of Examples 13-15, to include or use, wherein the transceiver and processing circuitry to monitor the throughput available on the MA USB device to determine if the throughput available on the MA USB device has increased includes the transceiver and processing circuitry to determine if the throughput available has increased to an amount sufficient to support reliable communication with a non-MA USB device for which enumeration has failed.

Example 17 can include or use, or can optionally be combined with the subject matter of Example 16, to include or use, wherein the throughput negotiation includes the transceiver and processing circuitry to receive a required throughput from the MA USB host and wherein the transceiver and processing circuitry too determine if the throughput available has increased to an amount sufficient to support reliable communication with the MA USB host includes the transceiver and processing circuitry to determine if the available throughput at the MA USB device is greater than or equal to the required throughput.

Example 18 can include or use, or can optionally be combined with the subject matter of at least one of Examples 13-17, to include or use, wherein the transceiver and processing circuitry to provide the throughput change notification includes the transceiver and processing circuitry to provide an indication of the amount of throughput available on the MA USB device.

Example 19 can include or use, or can optionally be combined with the subject matter of at least one of Examples 13-18, to include or use, wherein the transceiver and processing circuitry to monitor the throughput available on the MA USB device to determine whether the throughput available on the MA USB device has increased includes the transceiver and processing circuitry to periodically provide an indication of currently available throughput at the MA USB device.

Example 20 may include or use subject matter (such as an apparatus, a method, a means for performing acts, or a device readable memory including instructions that, when performed by the device, may configure the device to perform acts), such as may include or use a method performed by a media agnostic (MA) universal serial bus (USB) host comprising determining, by processing circuitry, that throughput is denied based on a throughput negotiation performed in response to receiving a new device connection notification from an MA USB device attempting to communicate with the MA USB host, in response to determining the throughput is denied, monitoring the throughput available on the MA USB host to determine whether the throughput available on the MA USB host has increased, generating a throughput change notification in response to a determination the throughput available on the MA USB host has increased, and initiating a second enumeration process in response to a determination the throughput available on the MA USB host has increased.

Example 21 can include or use, or can optionally be combined with the subject matter of Example 20, to include or use initiating a timer in response to a determination the throughput is denied, and in response to the timer expiring and determining the throughput available at the MA USB host has not increased sufficiently, providing an indication to the MA USB device that the first enumeration has failed.

Example 22 can include or use, or can optionally be combined with the subject matter of Example 21, to include or use, wherein determining the throughput available at the MA USB host has not increased sufficiently includes determining that the throughput has not increased by a threshold amount or enough to accommodate one or more devices that have failed the first enumeration due to lack of throughput.

Example 23 can include or use, or can optionally be combined with the subject matter of at least one of Examples 20-22, to include or use, wherein monitoring the throughput available on the MA USB host to determine if the throughput available on the MA USB host has increased includes determining if the throughput available has increased by a threshold amount.

Example 24 can include or use, or can optionally be combined with the subject matter of at least one of Examples 20-23, to include or use, wherein monitoring the throughput available on the MA USB host to determine if the throughput available on the MA USB host has increased includes determining if the throughput available has increased to an amount sufficient to support communication with the MA USB device and the MA USB host.

Example 25 can include or use, or can optionally be combined with the subject matter of Example 24, to include or use, wherein performing the throughput negotiation with the MA USB device includes receiving a required throughput from the MA USB device and determining if the throughput available has increased to an amount sufficient to support communication with the non-MA USB device includes determining if the available throughput is greater than or equal to the provided required throughput.

Example 26 can include or use, or can optionally be combined with the subject matter of at least one of Examples 20-25, to include or use, wherein providing the throughput change notification includes providing an indication of the amount of throughput available on the MA USB device.

Example 27 can include or use, or can optionally be combined with the subject matter of at least one of Examples 20-26, to include or use, wherein monitoring the throughput available on the MA USB host to determine whether the throughput available at the MA USB host has increased includes periodically determining currently available throughput at the MA USB host.

Example 28 can include or use, or can optionally be combined with the subject matter of at least one of Examples 20-27, to include or use, in response to a determination the throughput is denied based on the throughput negotiation, recording a device identification and throughput required for communication with the MA USB device on a list of devices that have failed enumeration, and in response to the throughput change notification, initiating the second enumeration process for those devices on the list of devices that failed enumeration and for which sufficient throughput is available at the MA USB host.

Example 29 can include or use, or can optionally be combined with the subject matter of at least one of Examples 20-28, to include or use in response to determining that throughput is denied based on the throughput negotiation, recording a device identification, throughput required for the non-MA USB device, and a priority of the MA USB device on a list of devices that failed enumeration, and wherein the second enumeration process is initiated for a device with a highest priority on the list of devices that failed enumeration.

Example 30 can include or use, or can optionally be combined with the subject matter of Example 29, to include or use, wherein the priority includes first come first served, and initiating the second enumeration process includes initiating the second enumeration process for a device in the list with the highest priority that has a required throughput less than or equal to the throughput available at the MA USB host.

Example 31 can include or use, or can optionally be combined with the subject matter of at least one of Examples 20-30, to include or use, wherein initiating the second enumeration process in response to a determination the throughput available on the MA USB host has increased includes providing an enumeration initiation communication to the MA USB device, receiving another new device connection notification from the MA USB device attempting to connect to the non-MA USB device communicatively connected to the MA USB host, performing another throughput negotiation with the MA USB device, and performing an open endpoint process, in response to determining there is sufficient throughput based on the throughput negotiation.

Example 32 can include or use, or can optionally be combined with the subject matter of at least one of Examples 20-31, to include or use a non-transitory machine-readable medium including instructions stored thereon which, when executed by the machine, configure the machine to perform operations comprising one or more of the methods of Examples 20-31.

Example 33 may include or use subject matter (such as an apparatus, a method, a means for performing acts, or a device readable memory including instructions that, when performed by the device, may configure the device to perform acts), such as may include or use a method performed by a media agnostic (MA) universal serial bus (USB) device, the method comprising initiating a first enumeration process by providing a new device connection notification to an MA USB host, performing the first enumeration process including performing a throughput negotiation with the MA USB host, determining that throughput is denied based on the throughput negotiation, and providing a throughput change notification to the MA USB host in response to determining the throughput is denied and throughput available at the MA USB device has increased, and performing a second enumeration process in response to receiving an enumeration request from the MA USB host and after providing the throughput change notification to the MA USB host.

Example 34 can include or use, or can optionally be combined with the subject matter of Example 33, to include or use initiating a timer in response to determining that the throughput is denied, and in response to the timer expiring and determining that the throughput available on the MA USB device has not increased, determining that the first enumeration process has failed.

Example 35 can include or use, or can optionally be combined with the subject matter of at least one of Examples 33-34, to include or use, wherein monitoring the throughput available on the MA USB device to determine if the throughput available on the MA USB device has increased includes determining if the throughput available has increased by a threshold amount.

Example 36 can include or use, or can optionally be combined with the subject matter of at least one of Examples 33-35, to include or use, wherein monitoring the throughput available on the MA USB device to determine if the throughput available on the MA USB device has increased includes determining if the throughput available has increased to an amount sufficient to support reliable communication with a non-MA USB device for which enumeration has failed.

Example 37 can include or use, or can optionally be combined with the subject matter of Example 36, to include or use, wherein the throughput negotiation includes receiving a required throughput at the MA USB device and wherein determining if the throughput available has increased to an amount sufficient to support reliable communication with the MA USB host includes determining if the available throughput at the MA USB device is greater than or equal to the required throughput.

Example 38 can include or use, or can optionally be combined with the subject matter of at least one of Examples 33-37, to include or use, wherein providing the throughput change notification provides an indication of the amount of throughput available on the MA USB device.

Example 39 can include or use, or can optionally be combined with the subject matter of at least one of Examples 33-38, to include or use, wherein monitoring the throughput available on the MA USB device to determine whether the throughput available on the MA USB device has increased includes periodically providing an indication of currently available throughput at the MA USB device.

Example 40 can include or use, or can optionally be combined with the subject matter of at least one of Examples 33-39, to include or use a non-transitory machine-readable medium including instructions stored thereon which, when executed by the machine, configure the machine to perform operations comprising one or more of the methods of Examples 33-39.

The above detailed description includes references to the accompanying drawings, which form a part of the detailed description. The drawings show, by way of illustration, specific embodiments in which methods, apparatuses, and systems discussed herein may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of“at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

As used herein, a “-” (dash) used when referring to a reference number means “or”, in the non-exclusive sense discussed in the previous paragraph, of all elements within the range indicated by the dash. For example, 103A-B means a nonexclusive “or” of the elements in the range {103A, 103B}, such that 103A-103B includes “103A but not 103B”, “103B but not 103A”, and “103A and 103B”.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A media agnostic (MA) universal serial bus (USB) host comprising:
processing circuitry; and
a transceiver communicatively coupled to processing circuitry, the transceiver and processing circuitry to perform a first enumeration process, including the transceiver and processing circuitry to:
determine that throughput is denied based on a throughput negotiation performed in response to receiving a new device connection notification from an MA USB device attempting to communicate with the MA USB host,
in response to a determination the throughput is denied, monitor the throughput available on the MA USB host to determine whether the throughput available on the MA USB host has increased,
generate a throughput change notification in response to a determination the throughput available on the MA USB host has increased, and
initiate a second enumeration process in response to a determination the throughput available on the MA USB host has increased.

2. The MA USB host of claim 1, wherein the transceiver and processing circuitry are further to:
initiate a timer in response to a determination the throughput is denied, and
in response to the timer expiring and a determination the throughput available at the MA USB host has not increased sufficiently, provide an indication to the MA USB device that the first enumeration has failed.

3. The MA USB host of claim 2, wherein the determination the throughput available at the MA USB host has not increased sufficiently includes a determination that the throughput has not increased by a threshold amount or enough to accommodate one or more devices that have failed the first enumeration due to lack of throughput.

4. The MA USB host of claim 1, wherein the transceiver and processing circuitry to monitor the throughput available on the MA USB host to determine if the throughput available on the MA USB host has increased includes transceiver and processing circuitry to determine if the throughput available has increased by a threshold amount.

5. The MA USB host of claim 1, wherein transceiver and processing circuitry to monitor the throughput available on the MA USB host to determine if the throughput available on the MA USB host has increased includes transceiver and processing circuitry to determine if the throughput available has increased to an amount sufficient to support communication between the MA USB device and the MA USB host.

6. The MA USB host of claim 5, wherein the transceiver and processing circuitry are further to perform the throughput negotiation with the MA USB device include the transceiver and processing circuitry to receive a required throughput from the MA USB device and wherein the transceiver and processing circuitry to determine if the throughput available has increased to an amount sufficient to support communication with the MA USB device includes the transceiver and processing circuitry to determine if the available throughput is greater than or equal to the provided required throughput.

7. The MA USB host of claim 1, wherein the transceiver and processing circuitry to provide the throughput change notification includes the transceiver and processing circuitry to provide an indication of the amount of throughput available on the MA USB device.

8. The MA USB host of claim 1, wherein the transceiver and processing circuitry to monitor the throughput available on the MA USB host to determine whether the throughput available at the MA USB host has increased includes the transceiver and processing circuitry to periodically determine currently available throughput at the MA USB host.

9. The MA USB host of claim 1, wherein the processing circuitry is further to:
in response to a determination the throughput is denied based on the throughput negotiation, record a device identification and throughput required for communication with the MA USB device on a list of devices that have failed enumeration, and
in response to the throughput change notification, initiate the second enumeration process for those devices on the list of devices that failed enumeration and for which sufficient throughput is available at the MA USB host.

10. The MA USB host of claim 1, wherein the processing circuitry is further to:
in response to determining that throughput is denied based on the throughput negotiation, record a device identification, throughput required for the non-MA USB device, and a priority of the MA USB device on a list of devices that failed enumeration, and
wherein the second enumeration process is initiated for a device with a highest priority on the list of devices that failed enumeration.

11. The MA USB host of claim 10, wherein the priority includes first come first served, and the transceiver and processing circuitry to initiate the second enumeration process includes transceiver and processing circuitry to initiate the second enumeration process for a device in the list with the highest priority that has a required throughput less than or equal to the throughput available at the MA USB host.

12. The MA USB host of claim 1, wherein the transceiver and processing circuitry to initiate the second enumeration process in response to a determination the throughput available on the MA USB host has increased includes the processing circuitry to:
provide an enumeration initiation communication to the MA USB device,
receive another new device connection notification from the MA USB device attempting to connect to the MA USB host,
perform another throughput negotiation with the MA USB device, and
perform an open endpoint process, in response to determining there is sufficient throughput based on the throughput negotiation.

13. A non-transitory machine-readable storage device including instructions,
which when executed by the machine, configure the machine to:
initiate a first enumeration process by providing a new device connection notification to an MA USB host,
perform the first enumeration process including the transceiver and processing circuitry to:
perform a throughput negotiation with the MA USB host,
determine that throughput is denied based on the throughput negotiation, and
provide a throughput change notification to the MA USB host in response to determining the throughput is denied and throughput available at the MA USB device has increased, and
perform a second enumeration process in response to receiving an enumeration request from the MA USB host and after providing the throughput change notification to the MA USB host.

14. The storage device of claim 13, further comprising instructions which, when executed by the machine, further configure the machine to:
initiate a timer in response to determining that the throughput is denied, and
in response to the timer expiring and determining that the throughput available on the MA USB device has not increased, determine that the first enumeration process has failed.

15. The storage device of claim 13, wherein the instructions for monitoring the throughput available on the MA USB device to determine if the throughput available on the MA USB device has increased include instructions, which when executed by the machine, configure the machine to determine if the throughput available has increased by a threshold amount.

16. The storage device of claim 13, wherein the instructions for monitoring the throughput available on the MA USB device to determine if the throughput available on the MA USB device has increased include instructions which, when executed by the machine, configure the machine to determine if the throughput available has increased to an amount sufficient to support reliable communication with an MA USB device for which enumeration has failed.

17. The storage device of claim 16, wherein the throughput negotiation includes the MA USB host providing a required throughput to the MA USB device and wherein determining if the throughput available has increased to an amount sufficient to support reliable communication with the MA USB host includes determining if the available throughput at the MA USB device is greater than or equal to the required throughput.

18. A method performed by a media agnostic (MA) universal serial bus (USB) host comprising:
determining, by processing circuitry, that throughput is denied based on a throughput negotiation performed in response to receiving a new device connection notification from an MA USB device attempting to communicate with the MA USB host;
in response to determining the throughput is denied, monitoring the throughput available on the MA USB host to determine whether the throughput available on the MA USB host has increased;
generating a throughput change notification in response to a determination the throughput available on the MA USB host has increased; and
initiating a second enumeration process in response to a determination the throughput available on the MA USB host has increased.

19. The method of claim 18 further comprising:
initiating a timer in response to a determination the throughput is denied, and
in response to the timer expiring and determining the throughput available at the MA USB host has not increased sufficiently, providing an indication to the MA USB device that the first enumeration has failed.

20. The method of claim 19, wherein determining the throughput available at the MA USB host has not increased sufficiently includes determining that the throughput has not increased by a threshold amount or enough to accommodate one or more devices that have failed the first enumeration due to lack of throughput.
